(19) United States
(12) Patent Application Publication
(10) Pub. No.: US 2010/0049478 A1
(43) Pub. Date: Feb. 25, 2010

(54) SYSTEM AND METHOD OF DESIGNING A BUILDING SYSTEM

(76) Inventor: William C. Petro, Unionville (CA)

Correspondence Address: HODGSON RUSS LLP;THE GUARANTY BUILDING, 140 PEARL STREET, SUITE 100, BUFFALO, NY, 14202-4040, US

(21) Appl. No.: 12/545,486

(22) Filed: Aug. 21, 2009

Related U.S. Application Data
(60) Provisional application No. 61/090,773, filed on Aug. 21, 2008.

(51) Int. Cl. G06F 17/50

(52) U.S. Cl. 703/1

(57) ABSTRACT

Systems and methods of designing building systems are described. The building system designer is assisted in designing a building by a computer which identifies system components that are compatible with each other, and possibly with the type of building and/or building code.

### CROSS-REFERENCE TO RELATED APPLICATION

This application claims the benefit of priority to U.S. provisional patent application Ser. No. 61/090,773, filed on Aug. 21, 2008.

### FIELD OF THE INVENTION

The present invention relates to methods and systems for designing systems. The present invention may be embodied as a method and/or a system for creating systems found in a building, such as plumbing systems.

### BACKGROUND OF THE INVENTION

In the prior art, building designers found it difficult to identify and purchase components for a building system, such as a sink arrangement or a toilet arrangement. One reason for the difficulty is that building systems often have numerous components, even for seemingly simple systems, and those components are often provided by different manufacturers or distributors. For example, if the designer desired to determine all the components for a sink, the designer might need to order a counter, sink, drain, faucet, trap and all the connectors needed to hold these together and mount them in a wash room. The ability to have all of these components fit together was not always simple, and often resulted in one or more components failing to fit with others of the components.

In addition, even if the building designer ordered all the proper components, some of the components might not arrive in a timely fashion, thereby delaying installation of the system. Delays in constructing a building result in added costs. To guard against such delays, designers were required to inquire as to the availability of each and every component, which was itself time consuming and costly for the designer. Furthermore, if one or more components were not expected to be available in a timely fashion, the designer was required to look for substitutes, or change the design.

Also, it was often difficult for designers to determine whether a particular component was suitable for the type of building being designed. For example, a toilet designed for use in a hospital may not be suitable for use in a school. The prior art methods of designing building systems required designers to remember to check the suitability of a particular component with regard to the type of building being designed. Even if the designer remembered to check suitability, checking the suitability was a time-consuming endeavor.

All of these difficulties to designing building systems resulted in large amounts of time being required to design the systems needed for a building. In addition, the cost associated with designing building systems was increased.

### SUMMARY OF THE INVENTION

The invention may be embodied as a computer system for designing a building system, such as a plumbing system. In an embodiment of the invention there is a computer with a program for controlling the computer, a database in communication with the computer, and a memory for storing information about a building system being designed. In the database is stored information regarding components that may be selected for the building system. The program has instructions for causing the computer to communicate with a building designer, the database and the memory. The instructions of the program may cause the computer to prompt the designer to identify a first building system component for which there is information in the database. For example the building system may be a toilet system, and the first building system component may be a toilet base. The instructions of the program may cause the computer to store in the memory information about the first building system component which is selected in response to the prompt.

The program may include instructions for causing the computer to provide the designer with information from the database about a second building system component for which there is information in the database. For example, the second building system component may be a toilet seat. The second building system component that is identified may be one which is compatible with the identified first building system component. So, for example, the designer of a toilet system will be assisted in selecting a toilet base and a toilet seat that are compatible with each other.

In an embodiment of the invention, the program also includes instructions for causing the computer to provide the designer with information from the database about a third building system component having information in the database. The third building system component is listed in the database, but is not identified in the database as being compatible with the identified first building system component. In such a system, information provided to the designer via the computer as a result of the program instructions includes an indication that the third building system component is not compatible with the first building system component.

In an embodiment of the invention, the program may include instructions for (a) prompting the designer via the computer to identify a type of building system being designed, (b) receiving an identification of the building system, and (c) providing the designer with an initial list of components. For example, the type of building system may be a toilet system. The initial list of components may include only components that are identified in the database as being compatible with the identified building system. The program may also include instructions for causing the computer to prompt the designer to select the first building system component from the initial list.

In another embodiment of the invention, the initial list of components may include information about components that are listed in the database, but which are not identified in the database as being compatible with the identified building system. In such a system, the program may include instructions for providing a non-compliant indication corresponding to those components on the initial list that are not identified in the database as being compatible with the identified building system.

The program also may include instructions for causing the computer to (a) receive a selection from the initial list, and (b) provide a subsequent list of components. The subsequent list may include only information about building system components that are identified in the database as being compatible with the identified building system. The program also may include instructions for causing the computer to prompt the designer to identify the second building system component from the subsequent list.

In one embodiment of the invention, the program includes instructions for causing the computer to (a) prompt the designer to identify a type of building for which the system is being designed, (b) receive an identification of the type of building, and then (c) provide the designer with an initial list of components, the initial list including only components that are identified in the database as being compatible with the identified type of building, and (d) prompting the designer to select the first building system component from the initial list. In order to execute further steps, the program may include instructions for causing the computer to (i) receive a selection from the initial list, and (ii) provide a subsequent list of components that are identified in the database as being compatible with the identified type of building, and (iii) prompt the designer to identify the second building system component from the subsequent list.

The program also may include instructions for (a) causing the computer to query a manufacturer of the identified first building system component for an expected delivery time and/or expected cost of the identified first building system component, and/or (b) causing the computer to provide information about the identified first building system component to a manufacturer, which may include a location of a building in which the identified first building system component is intended to be used.

The invention may be embodied as a method. In one such method, a building system may be designed by (a) providing a computer having a program running thereon for controlling the computer, (b) providing a database in communication with the computer, and having stored on the database information regarding components that may be selected for a building system, (c) providing a memory for storing information about the building system being designed, (d) prompting the designer to identify to the computer a first building system component having information in the database, (e) storing information in the memory about the identified first building system component, and (f) providing information via the computer to the designer, the information being from the database and about a second building system component for which there is information in the database and which is identified in the database as being compatible with the identified first building system component.

A method according to the invention may be carried out so as to (a) prompt the designer to identify to the computer a type of building system being designed, (b) receive at the computer an identification of the type of building system being designed, (c) provide via the computer to the designer an initial list of components, the initial list including only components that are identified in the database as being compatible with the received building system identification, and (d) prompt the designer via the computer to select the first building system component from the initial list. When a selection from the initial list is received by the computer, the computer may be caused to (a) provide a subsequent list of components that are identified in the database as being compatible with the identified building system, and (b) prompt the designer via the computer to identify the second building system component from the subsequent list.

In an embodiment of the invention, the designer is prompted via the computer to identify the type of building for which the system is being designed. Then, the designer is provided with an initial list of components that are listed in the database, the initial list providing a non-compliant indication corresponding to components on the initial list that are not identified in the database as being compatible with the identified building system, and via the computer the designer is prompted to select the first building system component from the initial list.

Also, a method according to the invention may be carried out by providing to the designer via the computer information from the database about a third building system component having information in the database. The third building system component is not identified in the database as being compatible with the identified first building system component. In such an embodiment of the invention, the information provided to the designer from the database about the third building system component includes an indication that the third building system component is not compatible with the first building system component.

In addition, one embodiment of the invention may prompt the designer via the computer to identify a type of building for which the system is being designed. In such a method, an identification of the type of building is received by the computer, and the designer is then provided via the computer with an initial list of components. The initial list includes only components that are identified in the database as being compatible with the identified type of building. The designer is then prompted via the computer to select the first building system component from the initial list. Then, a selection may be made from the initial list and received by the computer and a subsequent list of components may be provided to the designer. The subsequent list may include information about components that are identified in the database as being compatible with the identified type of building. The designer may be prompted via the computer to identify the second building system component from the subsequent list.

Finally, embodiments of methods according to the invention may include causing the computer to query a manufacturer of the identified first building system component for an expected delivery time and/or cost of the identified first building system component. Also, embodiments of methods according to the invention may include causing the computer to provide information (such as the location of the building it is intended for) about the identified first building system component to a manufacturer, so that (for example) the manufacturer can decide whether to manufacture the identified first building system component or move the first building system component to a warehouse near the place where the first building system component is likely to be needed.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a schematic of a system according to the invention;

FIG. 2 is a flow chart illustrating a method according to the invention;

FIG. 3 is a flow chart illustrating a method according to the invention; and

FIG. 4 is a flow chart illustrating a method according to the invention.

### FURTHER DESCRIPTION OF THE INVENTION

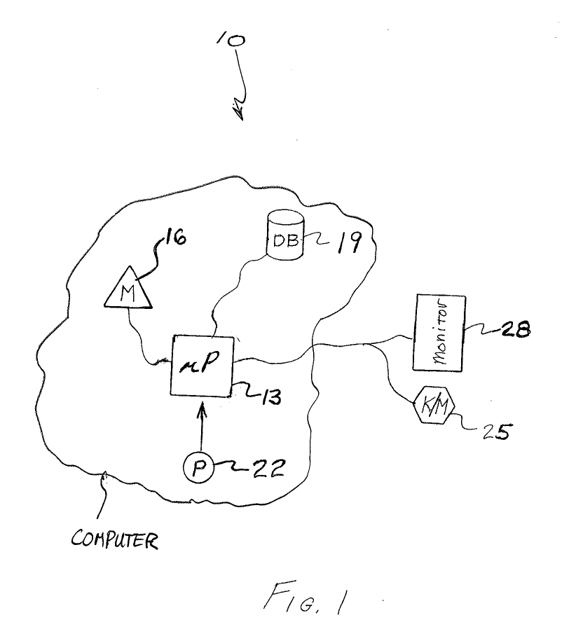

The invention may be embodied as a computer system 10, which may be used by building designers, for selecting the components for building systems. FIG. 1 depicts one such system 10. The computer system 10 may include a computer having a micro-processor 13, a memory 16, and a database 19. A computer program 22 may be loaded on the computer for causing the micro-processor 13 to perform certain tasks associated with the database 19 and the memory 16. The system 10 may utilize a web site to provide designers with access to the computer system 10, and in this manner, the designers may interface with the system 10 using their computer keyboard/mouse 25 and a monitor 28. The database 19 may contain information about components that a building designer might select for use in one or more building systems. The computer program 22 may be structured to cause the microprocessor 13 to provide the building designer with information about the building system components that are available for selection and receive from the designer selections of those components.

As an example, the database 19 may include a description of each toilet base, toilet seat, valve assembly, supplies, mounting carrier and flange that is available for selection in designing a toilet arrangement for a building. The computer program 22 may prompt the designer to identify the type of system being designed. Upon identifying that a toilet system is being designed, the computer program 22 may provide the designer with a list of toilet bases that may be selected. In one embodiment of the invention, the list of toilet bases may include not only the model number and manufacturer of each toilet base, but also may include helpful information such as the dimensions of the toilet base, water use, available colors, an image of the toilet, and other information that may be useful to the designer in selecting one toilet base over another. Of course, the invention is not limited to toilet systems, and may be implemented to accommodate the design of many other types of building systems.

Upon selecting a particular component, such as a toilet base, the computer program 22 may cause the microprocessor 13 of the computer to provide the designer with a list of components that may be needed in order to provide a functional toilet system. For example, the designer may be provided with a list of the toilet seats that will fit with the selected toilet base, or a list of the valve assemblies that are compatible with the selected toilet base. As the designer selects each of the components in the building system, the microprocessor 13 of the computer may store the selections in the memory 16 for later use.

In an embodiment of the computer system 10, the computer program 22 may prompt the designer to identify the type of building being designed. With the type-of-building information, the computer system 10 may assist the designer by identifying components that may or may not be suitable for that building type. In one embodiment of the invention, the computer system 10 may be implemented so that the designer does not receive information for components that are not suitable for the type of building identified by the designer, even though the information is in the database. In another embodiment of the invention, the computer system 10 provides the designer with information for components that are not suitable for the type of building identified by the designer, but these are flagged as being non-compliant.

In order to provide such functionality, the computer system 10 may include a database 19 which contains not only all the components that a designer might select, but also contains information regarding the types of buildings in which one or more of those components is recommended for installation. Then, when deciding whether to provide information about a particular component to the designer, the computer system 10 will compare the type-of-building information identified by the designer with the type-of-building information stored in the database for the selected component, and then determine whether there is a match for the type-of-building information. In one embodiment of the invention, if there is a match, the designer is provided with the information corresponding to that component. However, if a match of the building-type information is not determined by the computer system 10, the designer will not be presented with the information corresponding to that component.

For example, the type of building might be a school, hospital, or restaurant. The database may include information for many types of toilet seats, some of which are suitable only for certain building types. Before presenting toilet seat information to the designer of a school, the computer system 10 may check the building-type information corresponding to each toilet seat as part of an effort to determine which toilet seats identified in the database are suitable for a school. If the building-type information does not indicate suitability for a school, then that toilet seat information will not be provided to the designer even though the information is stored in the database 19. In this manner, the designer will be provided with information only for those toilet seats that are indicated in the database 19 to be suitable for a school.

A similar response may be made with regard to a mis-match in building code information. For example, the database may include an indication about the suitability of each component for certain building codes. Using such a database, the designer may be prompted to identify the building code to which the system must comply, and then the designer may be provided with information only about those components which are identified in the database 19 to be compliant with that building code.

Alternatively, the designer may be provided with information about components regardless of their suitability for a previously identified building-type and/or building code, but the designer may be warned of the potentially unsuitable component. In such a computer system 10, the building-type information (or building code information) that is associated with information about components may be used to determine whether a warning indicator should be provided to the designer along with the component information. If the building-type information (or building code information) for a component does not match the building-type information (or building code information) in the database, then the component information provided to the designer may be provided in a different color, or an icon (such as a red flag) may be provided in order to signal to the designer that there is a mis-match between building types (or building codes).

Also, although the designer may be provided with information about components regardless of their suitability for a previously identified building-type or building code, the computer system 10 may prevent but not prohibit the designer from selecting that component. For example, if the designer chooses a component, and the computer system 10 determines that there is a match between the building-type or building code information for that component and the previously received building-type indication or building code indication from the designer, then the computer system 10 may accept the component selection. But, if the computer system 10 determines there is not a match between building-type or building code, then the computer system 10 may not accept the component selection, and provide the designer with a message explaining that there is a mis-match for the type of building. The designer might be prompted to confirm the component selection despite the mis-match in building type or building code, and if confirmed, then the selection may be accepted. In this manner, the computer system 10 uses the type-of-building information or building code information to assist the designer with choosing appropriate components for the building system, but also provides flexibility to the designer in selecting components that the computer system 10 determines to be unsuitable for the building being designed.

As another example, if the installation designer chooses a particular sink, the computer system may then automatically determine which drains and faucets are compatible with the chosen sink. Information may then be provided by the computer system 10 to the designer, which corresponds only to those drains and faucets that are determined by the computer system 10 to be compatible. In this manner, a sink system may be more easily designed.

In order to provide such functionality, the database 19 may include information regarding the compatibility between components, and the computer system checks the compatibility information before providing information about a component to the designer. In such a system, when deciding whether to provide information to a designer, the computer system 10 will compare the compatibility information stored in the database 19 for the chosen component, with the compatibility information stored in the database 19 for components that are believed to be needed or desirable for use with the chosen component. If the comparison of compatibility information indicates a match, the designer will be provided with information corresponding to those components. However, if the comparison of compatibility information does not indicate a match, the designer may not be provided with information corresponding to those components, thereby limiting the designer's choices to only those components that have been previously determined to be compatible. In this manner, the designer is assisted with designing a system for which the components have been previously determined to be compatible, and is not allowed to choose components that have not been previously determined to be compatible.

Alternatively, the invention may be implemented using a computer system 10 that informs the designer when information stored in the database 19 indicates that a component is not expected to match a previously chosen component. For example, if the designer chooses a faucet that requires a particular configuration of holes in the sink in order for proper installation of the faucet, and the designer previously chose a sink with a different hole configuration, the computer system 10 may warn the designer not to choose that particular sink/faucet combination. To provide such a warning, the faucet information provided to the designer may be provided in a particular color or have a particular icon (such as a red flag) when the compatibility information of the sink and the compatibility information of the faucet do not match. In this manner, the designer may be informed of a potential mis-match between components.

Also, although the computer system 10 may provide the designer with information about components regardless of their compatibility with previously chosen components, the computer system 10 may prevent but not prohibit the designer from choosing components with a potential incompatibility. For example, if the designer chooses a component, and the computer system 10 determines that the chosen component's compatibility information matches the compatibility information of previously chosen components, then the computer system 10 may accept the component choice. But, if the computer system 10 determines there is not a match between compatibility information, then the computer system 10 may not accept the new component choice, and provide the designer with a message explaining that there is a mis-match for the compatibility information. The designer might be prompted to confirm the component choice despite the mis-match in compatibility information, and if confirmed, then the choice may be accepted. In this manner, the computer system 10 uses the compatibility information to assist the designer with choosing appropriate components that are likely to be compatible with each other, but also provides flexibility to the designer in choosing components that the computer system 10 determines to be incompatible with each other.

The computer system may record a designer's current selections for an installation and may query manufacturers for the expected delivery time and/or cost. Information received from the manufacturers in response to such a query may be provided to the designer. By providing the designer with such information, the designer is afforded an opportunity to alter the design in order to better assure timely delivery of components.

Although the designer may change the selections before an order is placed, the computer system 10 may be programmed to provide preliminary design information to manufacturers, and that information may be used by the manufacturers in deciding whether to manufacture components. For example, the system might be used to store 30 designs for bathrooms, each by a different designer. A manufacturer might be provided with information that 23 of the 30 pending designs are considering use of a particular faucet. With that knowledge, a manufacturer might decide to manufacture that faucet in order to augment its existing supply of the faucet, and thereby assure that the faucet is available when the designers begin to finalize and purchase components. The manufacturer also might note the location of each of the pending designs, and decide to augment the stock of the faucets in warehouses near the proposed installations—in that manner the manufacturer can provide the faucets quickly to the installation sites, thereby giving a competitive advantage to that manufacturer, and assisting designers by providing the selected components in a timely fashion.

By using a system according to the invention, it is expected that time and money will be saved. For example, it is believed that the time required to design a building system, such as a plumbing specification, will be reduced by more than 90%.

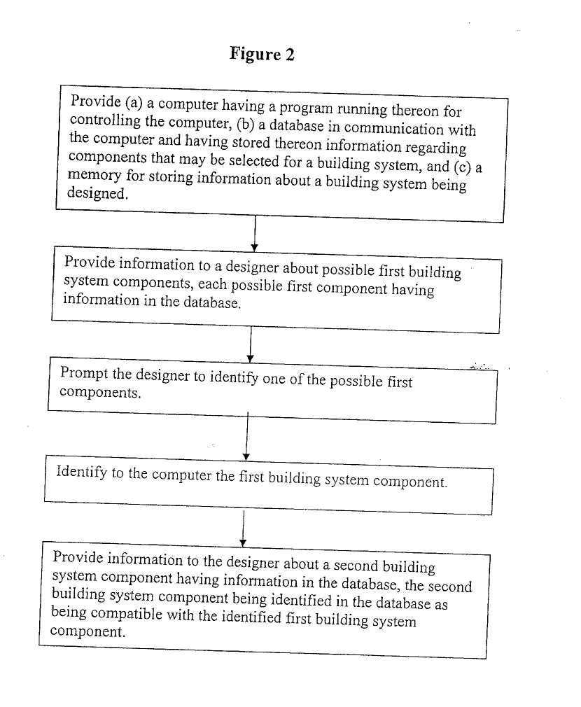

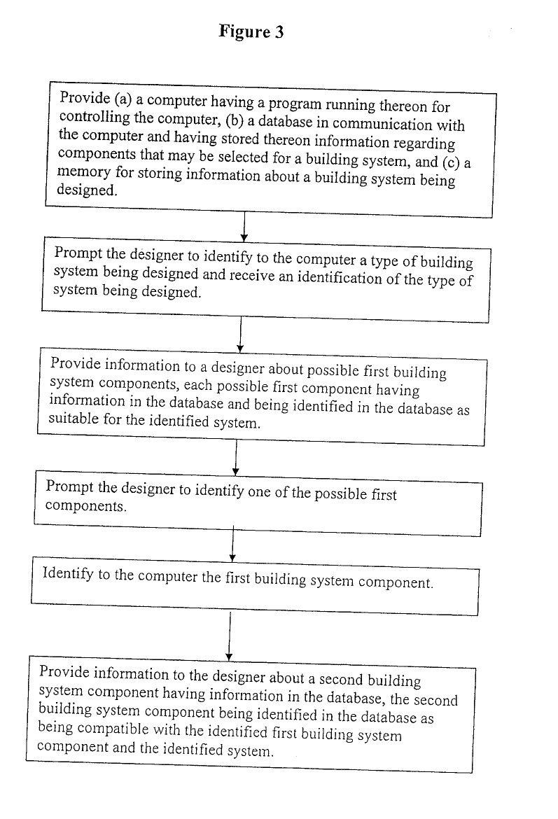

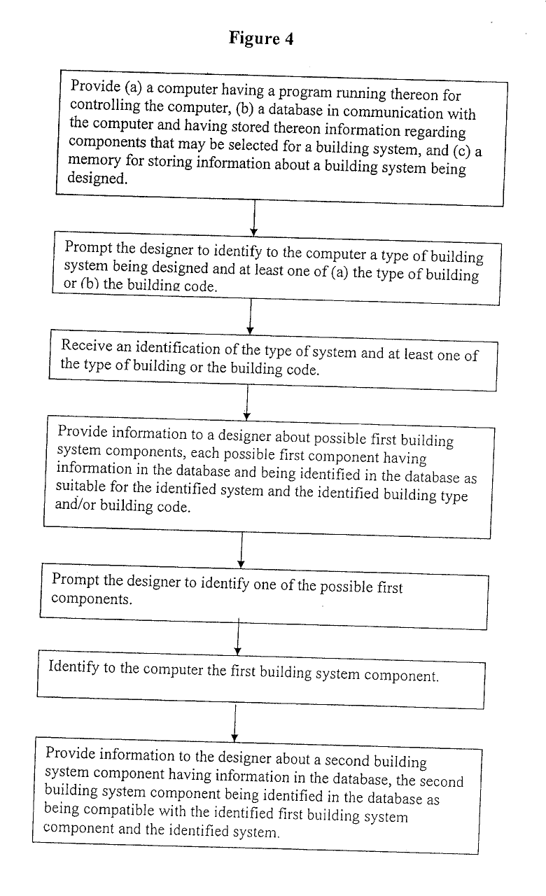

The invention may be embodied as a method. FIG. 2 describes one such method that may be executed by a system that is in keeping with the invention. FIG. 3 describes another method according to the invention that may be executed by a system that is in keeping with the invention. FIG. 4 describes another method according to the invention that may be executed by a system that is in keeping with the invention.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A computer system, comprising:
a computer having a program running thereon for controlling the computer;
a database in communication with the computer, and having stored thereon information regarding components that may be selected for a building system; and
a memory for storing information about a building system being designed;
wherein the program causes the computer to communicate with a building designer, the database and the memory, and wherein the program includes instructions for causing the computer to prompt the designer to identify a first building system component having information in the database, storing in the memory information about the identified first building system component, and providing the designer with information from the database about a second building system component having information in the database, the second building system component being identified in the database as being compatible with the identified first building system component.

2. The computer system of claim 1, wherein the program includes instructions for causing the computer to (a) prompt the designer to identify a type of building system being designed,
(b) receive an identification of the type of building system being designed, and then (c) provide the designer with an initial list of components, the initial list including only components that are identified in the database as being compatible with the received building system identification, and (d) prompting the designer to select the first building system component from the initial list.

3. The computer system of claim 2, wherein the program includes instructions for causing the computer to (a) receive a selection from the initial list, and (b) provide a subsequent list of components that are identified in the database as being compatible with the received building system identification, and (c) prompting the designer to identify the second building system component from the subsequent list.

4. The computer system of claim 1, wherein the program includes instructions for causing the computer to (a) prompt the designer to identify the type of building system being designed, (b) receive an identification of the type of building system being designed, and then (c) provide the designer with an initial list of components, the initial list providing a non-compliant indication corresponding to components on the initial list that are not identified in the database as being compatible with the identified building system, and (d) prompting the designer to select the first building system component from the initial list.

5. The computer system of claim 1, wherein the program further includes instructions for causing the computer to provide the designer with information from the database about a third building system component having information in the database, the third building system component not being identified in the database as being compatible with the identified first building system component, and wherein the information from the database about the third building system component includes an indication that the third building system component is not compatible with the first building system component.

6. The computer system of claim 1, wherein the program includes instructions for causing the computer to (a) prompt the designer to identify a type of building for which the system is being designed, (b) receive an identification of the type of building, (c) provide the designer with an initial list of components, the initial list including only components that are identified in the database as being compatible with the identified type of building, and (d) prompting the designer to select the first building system component from the initial list.

7. The computer system of claim 6, wherein the program includes instructions for causing the computer to (a) receive a selection from the initial list, and (b) provide a subsequent list of components that are identified in the database as being compatible with the type of building identification, and (c) prompt the designer to identify the second building system component from the subsequent list.

8. The computer system of claim 1, wherein the program includes instructions for causing the computer to (a) prompt the designer to identify a building code for which the system is being designed, (b) receive an identification of the building code, (c) provide the designer with an initial list of components, the initial list including only components that are identified in the database as being compatible with the identified building code, and (d) prompting the designer to select the first building system component from the initial list.

9. The computer system of claim 8, wherein the program includes instructions for causing the computer to (a) receive a selection from the initial list, and (b) provide a subsequent list of components that are identified in the database as being compatible with the building code, and (c) prompt the designer to identify the second building system component from the subsequent list.

10. The computer system of claim 1, wherein the program includes instructions for causing the computer to query a manufacturer of the identified first building system component for an expected delivery time of the identified first building system component.

11. The computer system of claim 1, wherein the program includes instructions for causing the computer to query a manufacturer of the identified first building system component for an expected cost of the identified first building system component.

12. The computer system of claim 1, wherein the program includes instructions for causing the computer to provide information about the identified first building system component to a manufacturer.

13. The computer system of claim 12, wherein the information provided to the manufacturer includes a location of a building in which the identified first building system component is intended to be used.

14. A method of designing a building system, comprising:
providing a computer having a program running thereon for controlling the computer;
providing a database in communication with the computer, and having stored thereon information regarding components that may be selected for a building system; and
providing a memory for storing information about a building system being designed;
prompting a designer to identify to the computer a first building system component having information in the database;
storing in the memory information about the identified first building system component;
providing via the computer to the designer information from the database about a second building system component having information in the database, the second building system component being identified in the database as being compatible with the identified first building system component.

15. The method of claim 14, further comprising:
prompting the designer to identify to the computer a type of building system being designed;
receiving at the computer an identification of the type of building system being designed;
providing via the computer to the designer an initial list of components, the initial list including only components that are identified in the database as being compatible with the received building system identification; and
prompting the designer via the computer to select the first building system component from the initial list.

16. The method of claim 15, further comprising:
receiving via the computer a selection from the initial list;
providing via the computer a subsequent list of components that are identified in the database as being compatible with the received type of building system identification; and
prompting the designer via the computer to identify the second building system component from the subsequent list.

17. The method of claim 14, further comprising:
prompting the designer via the computer to identify the type of building system being designed;
receiving via the computer an identification of the type of building system being designed;
providing the designer via the computer an initial list of components, the initial list providing a non-compliant indication corresponding to components on the initial list that are not identified in the database as being compatible with the identified building system; and
prompting the designer to select the first building system component from the initial list.

18. The method of claim 14, further comprising, providing the designer via the computer with information from the database about a third building system component having information in the database, the third building system component not being identified in the database as being compatible with the identified first building system component, and wherein the information from the database about the third building system component includes an indication that the third building system component is not compatible with the first building system component.

19. The method of claim 14, further comprising:
prompting the designer via the computer to identify a type of building for which the building system is being designed;
receiving via the computer an identification of the type of building being designed;
providing the designer via the computer with an initial list of components, the initial list including only components that are identified in the database as being compatible with the received type of building identification; and
prompting the designer via the computer to select the first building system component from the initial list.

20. The method of claim 19, further comprising:
receiving via the computer a selection from the initial list;
providing via the computer a subsequent list of components that are identified in the database as being compatible with the identified type of building; and
prompting the designer via the computer to identify the second building system component from the subsequent list.

21. The method of claim 14, further comprising:
prompting the designer via the computer to identify a type of building for which the building system is being designed;
receiving via the computer an identification of the type of building being designed;
providing the designer via the computer with an initial list of components, the initial list including only components that are identified in the database as being compatible with the received type of building identification; and
prompting the designer via the computer to select the first building system component from the initial list.

22. The method of claim 21, further comprising:
receiving via the computer a selection from the initial list;
providing via the computer a subsequent list of components that are identified in the database as being compatible with the identified type of building; and
prompting the designer via the computer to identify the second building system component from the subsequent list.

23. The method of claim 14, further comprising causing the computer to query a manufacturer of the identified first building system component for an expected delivery time of the identified first building system component.

24. The method of claim 14, further comprising causing the computer query a manufacturer of the identified first building system component for an expected cost of the identified first building system component.

25. The method of claim 14, further comprising causing the computer to provide information about the identified first building system component to a manufacturer.

26. The method of claim 25 wherein the information provided to the manufacturer includes a location of a building in which the identified first building system component is intended to be used.
